(19) United States
(12) Patent Application Publication
(10) Pub. No.: US 2022/0242363 A1
(43) Pub. Date: Aug. 4, 2022

(54) VEHICLE SEATBELT DEVICE

(71) Applicant: HONDA MOTOR CO., LTD., Tokyo (JP)

(72) Inventors: Shinsuke Odai, Wako-shi (JP); Yuji Yasui, Wako-shi (JP); Kenji Komori, Wako-shi (JP); Yosuke Sakamoto, Wako-shi (JP); Yosuke Koike, Wako-shi (JP); Kenshi Torikai, Wako-shi (JP)

(21) Appl. No.: 17/585,617

(22) Filed: Jan. 27, 2022

(30) Foreign Application Priority Data
Feb. 4, 2021 (JP) 2021-016676

(51) Int. Cl. B60R 22/46; B60R 22/48

(52) U.S. Cl. CPC B60R 22/46; B60R 2022/4841; B60R 2022/485; B60R 22/48

(57) ABSTRACT

A vehicle seatbelt device of an embodiment includes a recognizer that recognizes circumstances around a vehicle, a determiner that determines the state of the vehicle, a seatbelt that restrains a portion of the body of a driver of the vehicle, a tension adjustment mechanism that is able to adjust the tension of the seatbelt, a determiner that determines whether or not driving of the driver is a preferable method of driving on the basis of the circumstances recognized by the recognizer and the state determined by the determiner, and a controller that controls the tension adjustment mechanism such that a tension of the seatbelt varies when the determiner determines that driving of the driver is the preferable method of driving.

### CROSS-REFERENCE TO RELATED APPLICATION

This application is based upon and claims the benefit of priority from Japanese Patent Application No. 2021-016676, filed Feb. 4, 2021, the entire contents of which is incorporated herein by reference.

### BACKGROUND

### Field of the Invention

The present invention relates to a vehicle seatbelt device.

### Description of Related Art

A technology for allowing a driver to recognize details of a warning by changing a tension of a seatbelt is known (for example, refer to Japanese Unexamined Patent Application, First Publication No. 2008-24074).

### SUMMARY

In the technologies in the related art, an issue of improving awareness of safe driving of a driver has not been sufficiently studied.

The present invention has been made in consideration of such circumstances, and an object thereof is to provide a vehicle seatbelt device capable of improving awareness of safe driving of a driver.

A vehicle seatbelt device according to this invention employs the following constitutions.

(1) A first aspect of the present invention is a vehicle seatbelt device including a recognizer that recognizes circumstances around a vehicle, a determiner that determines the state of the vehicle, a seatbelt that restrains a portion of the body of a driver of the vehicle, a tension adjustment mechanism that is able to adjust the tension of the seatbelt, a determiner that determines whether or not driving of the driver is a preferable method of driving on the basis of the circumstances recognized by the recognizer and the state determined by the determiner, and a controller that controls the tension adjustment mechanism such that a tension of the seatbelt varies when the determiner determines that driving of the driver is the preferable method of driving.

(2) According to a second aspect of the present invention, in the first aspect, the determiner determines that driving of the driver is the preferable method of driving when the vehicle is traveling in a city area and the vehicle decelerates or stops in order to give way to a different mobile object.

(3) According to a third aspect of the present invention, in the first or second aspect, the determiner determines that driving of the driver is the preferable method of driving when a speed of the vehicle is equal to or lower than a threshold at a point of time when the vehicle arrives at a curved road.

(4) According to a fourth aspect of the present invention, in any one of the first to third aspects, the vehicle seatbelt device further includes a display that displays an image. The controller causes the display to display a predetermined image when the determiner determines that driving of the driver is the preferable method of driving.

(5) According to a fifth aspect of the present invention, in the fourth aspect, the controller changes a mode of the predetermined image between when the determiner determines that driving of the driver is the preferable method of driving and when the determiner determines that driving of the driver is not the preferable method of driving.

(6) According to a sixth aspect of the present invention, in the fourth or fifth aspect, the controller changes a mode of the predetermined image in accordance with the number of times the determiner has determined that driving of the driver is the preferable method of driving.

(7) According to a seventh aspect of the present invention, in any one of the fourth to sixth aspects, the controller changes a display frequency of the predetermined image in accordance with the number of times the determiner has determined that driving of the driver is the preferable method of driving.

(8) According to an eighth aspect of the present invention, in the seventh aspect, the controller decreases the display frequency of the predetermined image when the number of times the determiner has determined that driving of the driver is the preferable method of driving increases.

(9) According to a ninth aspect of the present invention, in any one of the first to eighth aspects, the controller changes a frequency of changing a tension of the seatbelt in accordance with the number of times the determiner has determined that driving of the driver is the preferable method of driving.

(10) According to a tenth aspect of the present invention, in the ninth aspect, the controller decreases a frequency of changing a tension of the seatbelt when the number of times the determiner has determined that driving of the driver is the preferable method of driving increases.

According to the foregoing aspect, awareness of safe driving of a driver can be improved.

### BRIEF DESCRIPTION OF THE DRAWINGS

FIG. 1 is a view showing an example of a constitution of a vehicle seatbelt device.

FIG. 2 is a view illustrating an example of an inside of a host vehicle M in which a display device is mounted.

FIG. 3 is an explanatory view for a lenticular lens structure of the display device.

FIG. 4 is an explanatory view for a function of the display device.

FIG. 5 is an explanatory view for a relationship between detection of an object by a vehicle exterior camera and display of an image object by the display device.

FIG. 6 is a flowchart showing a flow of a series of processing by a control device.

FIG. 7 is a view illustrating a scene in which a driver has not directed a visual line or the face to some risk points.

FIG. 8 is an explanatory view for a method of controlling each of instruments in the scene of FIG. 7.

FIG. 9 is an explanatory view for a control timing of a vibrator.

FIG. 10 is an explanatory view for a control timing of a pretensioner.

FIG. 11 is a view illustrating a scene in which a driver has directed a visual line or the face to all of the risk points.

FIG. 12 is a view illustrating a scene of judging that manual driving of a driver is performed.

FIG. 13 is an explanatory view for the method of controlling each of the instruments when it is determined that driving is a preferable method of driving.

FIG. 14 is an explanatory view for a control timing of the pretensioner.

FIG. 15 is a view illustrating another scene of judging that manual driving of a driver is performed.

FIG. 16 is an explanatory view for the method of controlling each of the instruments when it is determined that driving is not preferable driving.

FIG. 17 is a view illustrating another scene of judging that manual driving of a driver is performed.

FIG. 18 is an explanatory view for details of control in accordance with the number of times manual driving has been complimented.

### DESCRIPTION OF EMBODIMENTS

Hereinafter, embodiments of the present invention will be described with reference to the drawings. In the following embodiments, a case in which regulations for left-hand traffic are applied will be described as an example. However, when regulations for right-hand traffic are applied, the left and right sides may be read in reverse.

### First Embodiment

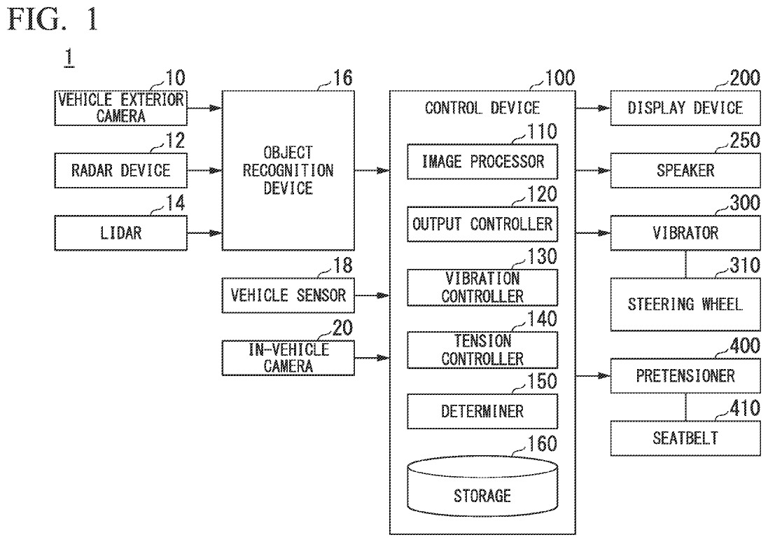

Hereinafter, a first embodiment will be described. FIG. 1 is a view showing an example of a constitution of a vehicle seatbelt device 1. For example, the vehicle seatbelt device 1 includes a vehicle exterior camera 10, a radar device 12, a light detection and ranging (LIDAR) device 14, an object recognition device 16, a vehicle sensor 18, an in-vehicle camera 20, a control device 100, a display device 200, a speaker 250, a vibrator 300, a steering wheel 310, a pretensioner 400, and a seatbelt 410. Hereinafter, a vehicle in which the vehicle seatbelt device 1 is mounted will be referred to as a host vehicle M in the description. An instrument in which some or all of the vehicle exterior camera 10, the radar device 12, the LIDAR device 14, and the object recognition device 16 are combined is an example of “a recognizer”.

For example, the vehicle exterior camera 10 is a digital camera utilizing a solid-state image capturing element such as a charge coupled device (CCD) or a complementary metal oxide semiconductor (CMOS). The vehicle exterior camera 10 is attached to an arbitrary place in the host vehicle M. The vehicle exterior camera 10 is attached to an upper part of a front windshield, a rear surface of a rear-view mirror, a front head of a vehicle body, or the like. When an image of a side behind the vehicle is captured, the vehicle exterior camera 10 may be attached to an upper part of a rear windshield, a back door, or the like or may be attached to a side mirror or the like.

The radar device 12 radiates radio waves such as millimeter waves to the vicinity of the host vehicle M and detects at least a position (a distance and an azimuth) of an object in the vicinity by detecting radio waves (reflected waves) reflected by the object. The radar device 12 is attached to an arbitrary place in the host vehicle M. The radar device 12 may detect a position and a speed of an object by a frequency modulated continuous wave (FM-CW) method.

The LIDAR device 14 emits light to the vicinity of the host vehicle M and measures scattered light. The LIDAR device 14 detects the distance to a target on the basis of a time from light emission to light reception. For example, emitted light is pulsed laser light. The LIDAR device 14 is attached to an arbitrary place in the host vehicle M.

The object recognition device 16 recognizes a position, a kind, a speed, and the like of an object in the vicinity of the host vehicle M by performing sensor fusion processing with respect to detection results by some or all of the vehicle exterior camera 10, the radar device 12, and the LIDAR device 14. Examples of an object include a different vehicle (for example, a peripheral vehicle present within a predetermined distance), a pedestrian, a bicycle, and a road structure. Examples of a road structure include a road sign, a traffic signal, a railroad crossing, a curbstone, a medial divider, a guardrail, and a fence. In addition, examples of a road structure may include a road demarcation line (which will hereinafter be referred to as a demarcation line) and a crosswalk which are painted or adhered on a road surface, and a road surface sign such as a bicycle crossing lane or a stop sign line. In addition, an object may include an obstacle such as a fallen object on a road (for example, a load of a different vehicle or a signboard installed in the vicinity of a road). The object recognition device 16 outputs recognition results to the control device 100. The object recognition device 16 may output detection results of the vehicle exterior camera 10, the radar device 12, and the LIDAR device 14 to the control device 100 without any change. In this case, the control device 100 may have functions of the object recognition device 16.

The vehicle sensor 18 includes a vehicle speed sensor for detecting a speed of the host vehicle M, an acceleration sensor for detecting an acceleration, a yaw rate sensor for detecting a yaw rate (for example, a rotation angular speed about a vertical axis passing through a centroidal point of the host vehicle M), an azimuth sensor for detecting a direction of the host vehicle M, and the like. The vehicle sensor 18 outputs signals indicating detection results such as a speed, a virtual degree yaw rate, and an azimuth angle to the control device 100. The vehicle sensor 18 is an example of “a determiner”.

Similar to the vehicle exterior camera 10, for example, the in-vehicle camera 20 is a digital camera utilizing a solid-state image capturing element such as a CCD or a CMOS. For example, the in-vehicle camera 20 is installed in the middle of an instrument panel of the host vehicle M and captures an image of the inside of a compartment. The in-vehicle camera 20 particularly captures an image of a driver of the host vehicle M and an occupant in a passenger seat and outputs the image to the control device 100.

For example, the control device 100 includes an image processor 110, an output controller 120, a vibration controller 130, a tension controller 140, a determiner 150, and a storage device 160. For example, these constituent elements are realized by a hardware processor such as a central processing unit (CPU) executing a program (software). Some or all of these constituent elements may be realized by hardware (a circuit; including circuitry) such as a large-scale integration (LSI), an application specific integrated circuit (ASIC), a field-programmable gate array (FPGA), or a graphics processing unit (GPU), or may be realized by software and hardware in cooperation. A program may be stored in the storage device 160 in advance or may be stored in an attachable/detachable storage medium (a non-transitory storage medium) such as a DVD or a CD-ROM such that the program is installed in the storage device 160 when the storage medium is mounted in a drive device. The output controller 120 and/or the tension controller 140 is an example of “a controller”.

The image processor 110 analyzes an image captured by the in-vehicle camera 20 and detects a direction of a visual line or a direction of the face of an occupant (particularly, a driver) of the host vehicle M.

The output controller 120 causes the display device 200 to three-dimensionally display a personified image (which will be described below) or the like or causes the speaker 250 to output a sound.

The vibration controller 130 controls the vibrator 300 to cause the steering wheel 310 to vibrate. The tension controller 140 controls the pretensioner 400 to adjust the tension of the seatbelt 410.

The determiner 150 determines whether or not manual driving of the driver of the host vehicle M is a preferable method of driving on the basis of recognition results of the object recognition device 16 and detection results of the vehicle sensor 18. Preferable driving is safe driving or fuel-efficient driving. Typically, preferable driving is driving in which the distance between a host vehicle and a different vehicle is appropriate, a host vehicle gives way to a different vehicle or a pedestrian, there are few sudden accelerations and decelerations, and/or there are few driving operations of steering.

For example, the storage device 160 is realized by an HDD, a flash memory, an electrically erasable programmable read-only memory (EEPROM), a read-only memory (ROM), a random-access memory (RAM), or the like. For example, the storage device 160 stores a program which is read and executed by the processor.

The display device 200 displays information output by the control device 100 as an image. For example, the display device 200 is a three-dimensional display (a hologram display) such as a looking glass having a lenticular lens structure. The display device 200 is an example of “a display”.

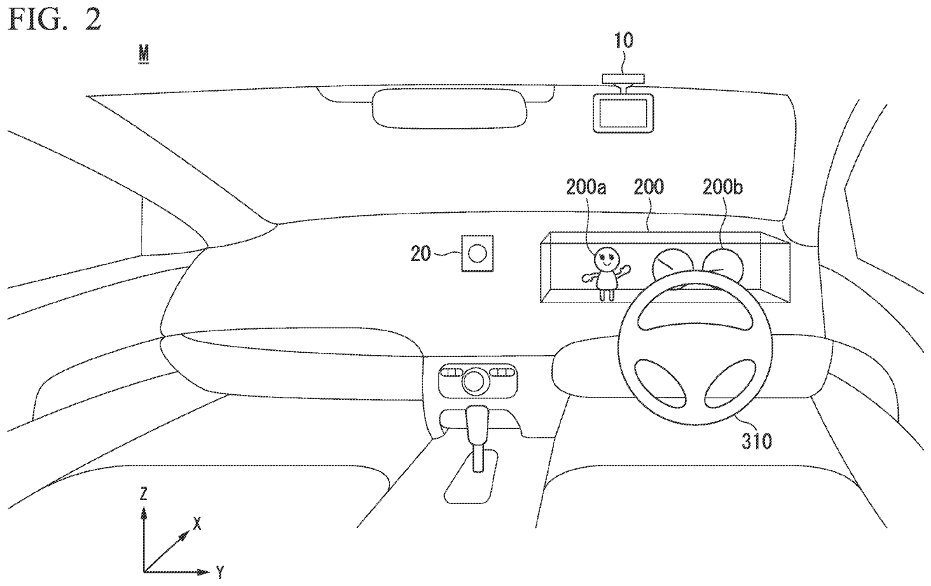

FIG. 2 is a view illustrating an example of an inside of the host vehicle M in which the display device 200 is mounted. As illustrated in FIG. 2, the display device 200 is installed at a position in the instrument panel facing a driver's seat. For example, the display device 200 displays a personified image 200a and a speedometer 200b. A personified image may be an image showing a human, an animal, a plant, a robot, or a different entity which is actually present or may be an image showing a fictional character (a character). Typically, a personified image is an image in which an item personified by animation moves.

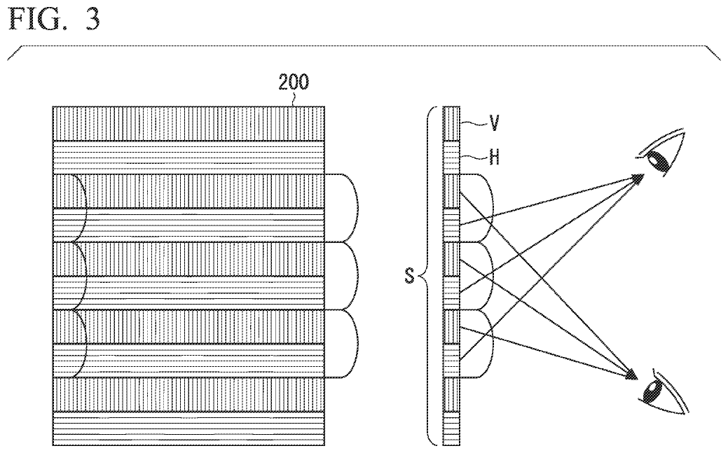

FIG. 3 is an explanatory view for a lenticular lens structure of the display device 200. In FIG. 3, a sheet (a lenticular lens) S in which innumerable micro-dome-shaped convex lenses are arranged is disposed on an image that is referred to as a lenticular image in which images of two kinds such as a vertical line V and a horizontal line H are combined. Since there is a parallax between two eyes of a user, one eye recognizes images of the vertical lines, and the other eye recognizes images of the horizontal lines through the sheet S. Accordingly, a user can recognize an image having a stereoscopic effect.

Returning to FIG. 1, the speaker 250 outputs information output by the control device 100 as an audio.

The vibrator 300 is embedded inside a portion of a casing such as a rim or a spoke of the steering wheel 310 or is attached to a surface of the casing. Typically, one vibrator 300 is provided on each of the rim on the left side and the rim on the right side when viewed from the driver.

The steering wheel 310 is an annular component which can adjust steering of the host vehicle M (a forward movement direction). In place of the steering wheel 310, a steering wheel having a different shape that is not an annular shape may be provided or a different operator such as a joystick may be provided in the host vehicle M. In this case, the vibrator 300 may be attached to a steering wheel having a different shape, a joystick, or the like.

The pretensioner 400 includes a mechanism for drawing in (winding) the seatbelt 410 in order to eliminate looseness of the seatbelt 410. The seatbelt 410 is a belt-shaped safety device for restraining the body of an occupant in the seat. For example, the pretensioner 400 intensifies the tension of the seatbelt 410 in stages by means of driving of a motor and operates so as to intensify the restraining force of the seatbelt 410. The pretensioner 400 is an example of “a tension adjustment mechanism”.

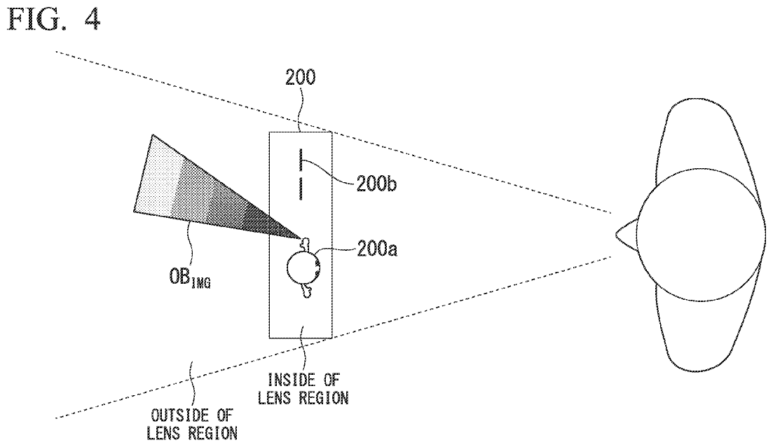

FIG. 4 is an explanatory view for a function of the display device 200. In FIG. 4, in addition to the personified image 200a and the speedometer 200b, the display device 200 continuously displays an image object OB_{IMG} spreading toward a side behind the personified image 200a. For example, the image object OB_{IMG} is displayed in the form of light, sand, or the like. Since the display device 200 can form an image in both the inside of a lens region and the outside of the lens region, a user can three-dimensionally recognize the image object OB_{IMG} spreading from the inside of the lens region toward the outside of the lens region. Meanwhile, the display device 200 also has characteristics in which visibility of an image formed outside the lens region is inferior to visibility of an image formed inside the lens region.

In FIG. 4, the display device 200 displays the image object OB_{IMG} in a shape of a continuous group, but the method of displaying the image object OB_{IMG} is not limited thereto. For example, the display device 200 may display the image object OB_{IMG} as a group of a plurality of elements which are intermittently distributed or may display it such that a plurality of elements flow in a certain direction.

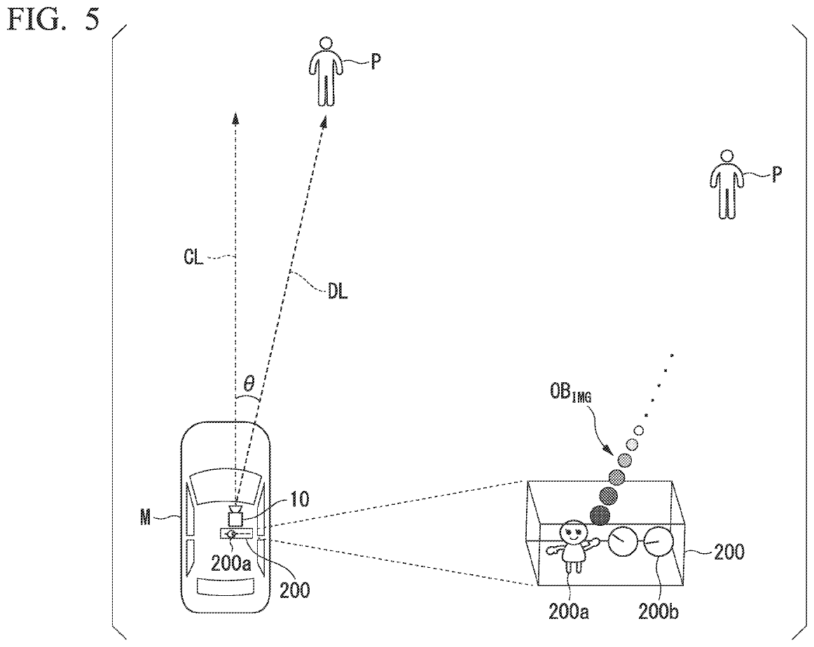

Next, a mechanism of notifying a user of the presence of an object in the vicinity of the host vehicle M using the vehicle exterior camera 10 and the display device 200 will be described. FIG. 5 is an explanatory view for a relationship between detection of an object by the vehicle exterior camera 10 and display of the image object OB_{IMG} by the display device 200. Here, an object present in front of the host vehicle M is detected and the distance and the angle between the host vehicle M and an object are measured exclusively using the vehicle exterior camera 10. In FIG. 5, the reference sign CL indicates an axial direction of the vehicle body of the host vehicle M, the reference sign P indicates a pedestrian, the reference sign DL indicates the distance between the host vehicle M and the pedestrian P, and the reference sign θ indicates an angle of a direction of the pedestrian P with respect to the axial direction CL of the vehicle body. The reference sign P is not limited to a pedestrian and may be a different obstacle such as an automobile or a bicycle.

The object recognition device 16 derives information of the distance DL and the angle θ (information of a height may be further included) by performing position conversion processing from an image-capturing space of the vehicle exterior camera 10 into a plane viewed from the sky. This processing may be performed in the display device 200 or may be performed by the processor which belongs to the vehicle exterior camera 10. The display device 200 acquires information of the distance DL and the angle θ from the object recognition device 16.

The output controller 120 obtains a spatial vector from the personified image 200a to the pedestrian P on the basis of the acquired information of the distance DL and the angle θ and information of the height from the personified image 200a of the display device 200 to the vehicle exterior camera 10. The output controller 120 calculates the direction of the image object OB_{IMG} displayed from a hand side of the personified image 200a toward the position of the pedestrian P on the basis of the obtained spatial vector.

Next, the output controller 120 determines a display mode of the image object OB_{IMG} displayed from the hand side of the personified image 200a toward the position of the pedestrian P on the basis of the detection results of the vehicle exterior camera 10 and the calculated direction of the image object OB_{IMG}. Specifically, the output controller 120 determines a density, a color intensity, a brightness, a size, or the like of the image object OB_{IMG}. The output controller 120 causes the display device 200 to display the image object OB_{IMG} on the basis of the determined display mode. The output controller 120 may change not only the image object OB_{IMG}but also the display mode of the personified image 200a.

In this manner, for example, the output controller 120 causes one or more image objects OB_{IMG} to be continuously displayed in a direction of an obstacle (an obstacle recognized by the object recognition device 16) outside the lens region from the inside of the lens region. In the example of FIG. 5, the position of the pedestrian P is an obstacle recognized by the object recognition device 16. Therefore, the image object OB_{IMG} is displayed toward the position of the pedestrian P.

In FIG. 5, the display device 200 displays the punctiform image object OB_{IMG} from the hand side of the personified image 200a toward the position of the pedestrian P. As described above, since the display device 200 has characteristics in which the visibility of an image formed outside the lens region is inferior to the visibility of an image formed inside the lens region, when the image object OB_{IMG} is displayed in the same mode, inferiority of visibility between the inside of the lens region and the outside of the lens region becomes noticeable so that a user may feel a sense of incompatibility. Hence, when the display device 200 displays one or more image objects OB_{IMG} from the inside of the lens region toward the outside of the lens region, the output controller 120 changes parameters such as the density, the color intensity, the brightness, and/or the size of the image object OB_{IMG} near the lens region compared to the image object OB_{IMG} away from an area near the lens region. For example, in FIG. 5, the output controller 120 causes the punctiform image object OB_{IMG} displayed at a position close to the personified image 200a to be larger than the punctiform image object OB_{IMG} away from the personified image 200a. Moreover, the output controller 120 causes the color of the punctiform image object OB_{IMG} close to the personified image 200a to be darker than the color of the punctiform image object OB_{IMG} away from the personified image 200a. In place of this or in addition to this, the output controller 120 may cause the brightness of the punctiform image object OB_{IMG} close to the personified image 200a to be higher than the brightness of the punctiform image object OB_{IMG} away from the personified image 200a. In addition, in place of this or in addition to this, the output controller 120 may cause the density of the punctiform image object OB_{IMG} close to the personified image 200a to be higher than the density of the punctiform image object OB_{IMG} away from the personified image 200a. In this manner, visual discontinuity of the image object OB_{IMG} can be reduced and a sense of incompatibility of a user can be reduced by determining the display mode such that the density, the color intensity, the brightness, and/or the size of the image object OB_{IMG} near the lens region vary compared to the image object OB_{IMG} away from an area near the lens region.

In the present embodiment, the display device 200 displays the image object OB_{IMG} from the hand side of the personified image 200a, but it is not limited thereto. A start point of the image object OB_{IMG} may be on an inward side or in the vicinity of the personified image 200a instead of the hand side of the personified image 200a.

### Processing Flow of Control Device

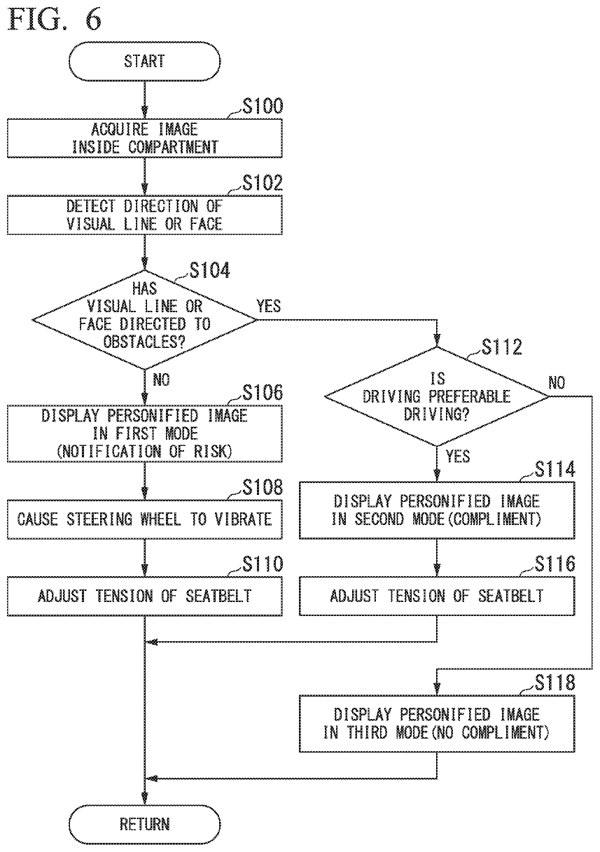

Hereinafter, a series of processing by the control device 100 will be described using a flowchart. FIG. 6 is a flowchart showing a flow of a series of processing by the control device 100. The processing of this flowchart may be repeatedly executed in a predetermined cycle.

First, the image processor 110 acquires an image inside the compartment from the in-vehicle camera 20 (Step S100), analyzes the acquired image, and detects a direction of a visual line or a direction of the face of an occupant (particularly, a driver) of the host vehicle M (Step S102).

Next, the output controller 120 determines whether or not the driver has directed a visual line or the face to all of the obstacles to be watched carefully by the driver of the host vehicle M of one or a plurality of obstacles (an automobile, a bicycle, a pedestrian, and the like) recognized by the object recognition device 16 (Step S104).

Typically, an obstacle to be watched carefully by the driver is an obstacle which is hidden at a blind spot from the host vehicle M (on a lateral side of, on a rear lateral side of, or behind the host vehicle M), but it is not limited thereto. An obstacle may be an obstacle in front thereof on which the driver has to keep an eye. Hereinafter, an obstacle to be watched carefully by the driver of the host vehicle M will be referred to as “a risk point PT”. Directing a visual line or the face to the risk point PT will be referred to as “eye-on”, and not doing so will be referred to as “eye-off” in the description.

For example, the output controller 120 may calculate an angle formed by a vector indicating a direction in which the risk point PT is present and a vector indicating the direction of a visual line or the direction of the face of the driver. It may be determined as eye-on when the formed angle is within an allowable angle, and it may be determined as eye-off when the formed angle is out of the allowable angle. An allowable angle is an angle to the extent that two vectors can be regarded as vectors in the same direction and may be an angle within a range of approximately several degrees to tens of degrees, for example.

When the driver has not directed a visual line or the face to some or all of the risk points PT (a case of eye-oft), the output controller 120 causes the display device 200 to display the personified image 200a or the image object OB_{IMG} in a first mode (Step S106). At this time, the output controller 120 may cause the speaker 250 to output a sound.

Next, the vibration controller 130 controls the vibrator 300 to cause the steering wheel 310 to vibrate (Step S108).

Next, the tension controller 140 controls the pretensioner 400 to adjust the tension of the seatbelt 410 (Step S110).

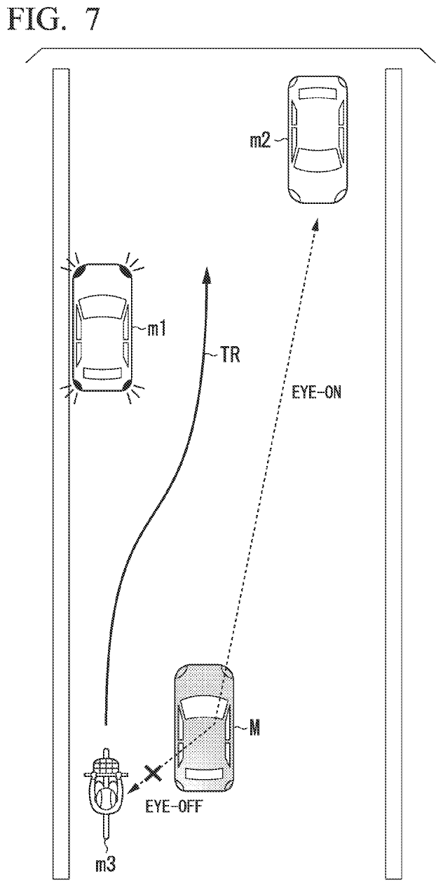

FIG. 7 is a view illustrating a scene in which a driver has not directed a visual line or the face to some risk points PT. In this scene, regulations for left-hand traffic are applied. The reference sign m1 in the diagram indicates a preceding vehicle which has stopped on a road shoulder in front of the host vehicle M. The reference sign m2 indicates an oncoming vehicle which is present in front of the host vehicle M. The reference sign m3 indicates a bicycle which travels behind the left side of the host vehicle M.

In the illustrated scene, the host vehicle M is traveling on a road in a city area having no centerline, and the preceding vehicle m1 has stopped on a road shoulder. For this reason, a space on the right side of the preceding vehicle m1 is narrowed so that two vehicles cannot pass through at the same time while passing by each other. Namely, there is a need for either the host vehicle M or the preceding vehicle m1 to give way to the other. For example, when the host vehicle M gives way to the preceding vehicle m1, there is a need for the host vehicle M to temporarily stop or slow down behind the preceding vehicle m1. At this time, as indicated by the trajectory TR in the diagram, it is postulated that the bicycle m3 passes by the host vehicle M which has stopped or slowed down (passing by the left side of the host vehicle M) and moves forward in front of the host vehicle M.

Under such circumstances, it is desired for the driver of the host vehicle M to carefully watch the oncoming vehicle m2 and the bicycle m3. Therefore, the output controller 120 regards the oncoming vehicle m2 and the bicycle m3 as the risk points PT and determines whether or not the driver has directed a visual line or the face to each of the two risk points PT. In the illustrated example, although the driver has directed a visual line or the face to the oncoming vehicle m2 of the two risk points PT, the driver has not directed a visual line or the face to the bicycle m3 (the driver is in the eye-off state with respect to the bicycle m3). In such a case, the display device 200, the vibrator 300, and the pretensioner 400 are controlled by a control method which will be described below. Particularly, the display device 200 displays the personified image 200a or the image object OB_{IMG} in the first mode.

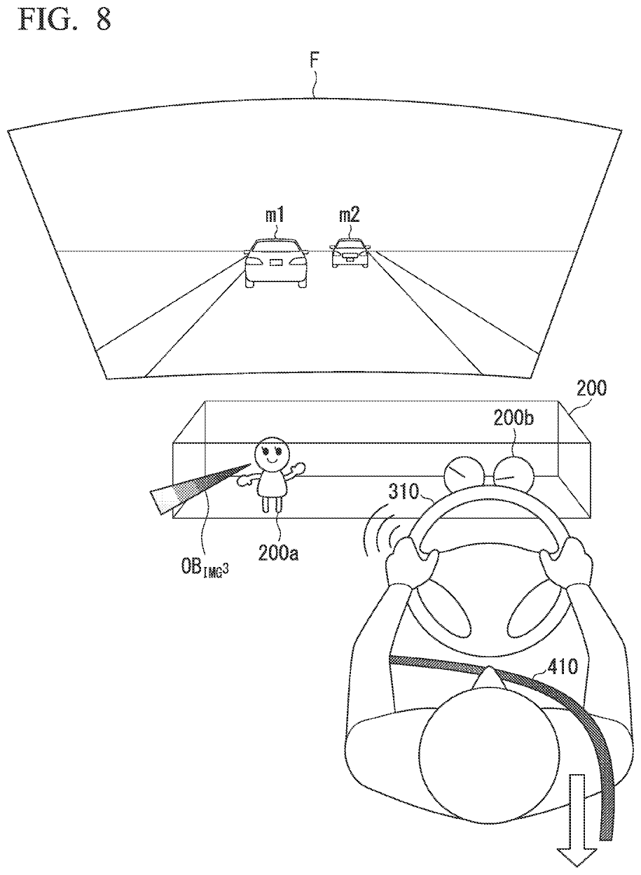

FIG. 8 is an explanatory view for a method of controlling each of instruments in the scene of FIG. 7. For example, when the host vehicle M encounters the scene of FIG. 7, although the driver can visually recognize the preceding vehicle m1 and the oncoming vehicle m2 over a front windshield F of the host vehicle M. However, since the bicycle m3 is positioned at a blind spot from a viewpoint of the driver, there is a need for the driver to look aside to check the lateral side and the driver to look back to check behind and utilize the rear-view mirror or the side mirror to check the lateral side or a side behind the host vehicle M.

For example, it is assumed that the driver has not directed a visual line or the face to the risk point PT. In this case, in the first mode, while pausing a character to be displayed as the personified image 200a, the output controller 120 further causes only the image object OB_{IMG} corresponding to the risk point PT (the risk point PT in the eye-off state) to which the driver has not directed a visual line or the face to be displayed around the character.

As in the scene of FIG. 7, when the driver has not directed a visual line or the face to the bicycle m3 (the risk point PT), the output controller 120 causes only an image object OB_{IMG}3 indicating a direction in which the bicycle m3 is present to be displayed by being disposed around the personified image 200a.

When the driver has not directed a visual line or the face to some risk points PT, the vibration controller 130 controls the vibrator 300 to cause the steering wheel 310 to vibrate. Specifically, when the risk point PT to which the driver has not directed a visual line or the face is present on the left side of the host vehicle M from a viewpoint of the driver, the vibration controller 130 controls the vibrator 300 to cause a part of the steering wheel 310 (the rim, the spoke, or the like) on the left side from a viewpoint of the driver to vibrate more intensively than a part on the right side. On the contrary, when the risk point PT to which the driver has not directed a visual line or the face is present on the right side of the host vehicle M from a viewpoint of the driver, the vibration controller 130 controls the vibrator 300 to cause a part of the steering wheel 310 on the right side from a viewpoint of the driver to vibrate more intensively than a part on the left side. Accordingly, the driver of the host vehicle M can be notified of the presence of an obstacle which is not recognized by the driver. As a result, the safety of the driver of the host vehicle M and an area around the host vehicle M can be further improved.

In the scene of FIG. 7, since the bicycle m3 is present behind the left side of the host vehicle M from a viewpoint of the driver, the vibration controller 130 causes a part of the steering wheel 310 on the left side to vibrate and does not cause a part of the steering wheel 310 on the right side to vibrate. Even if a part of the steering wheel 310 on the right side is not caused to actively vibrate, vibration at a part on the left side may be transferred thereto so that a part on the right side may passively vibrate. Even in such a case, in consideration of attenuation in vibration, vibration becomes more intensified at a part on the left side than at least a part on the right side.

When the driver has not directed a visual line or the face to some risk points PT, the tension controller 140 controls the pretensioner 400 to adjust the tension of the seatbelt 410. Specifically, when a certain risk point PT is present behind the host vehicle M from a viewpoint of the driver and the driver has not directed a visual line or the face to the risk point PT, the tension controller 140 controls the pretensioner 400 to intensify the tension of the seatbelt 410 compared to when the risk point PT is present behind the host vehicle M from a viewpoint of the driver and the driver has directed a visual line or the face to the risk point PT.

In the scene of FIG. 7, since the bicycle m3 is present behind the left side of the host vehicle M from a viewpoint of the driver, the tension controller 140 intensifies the tension of the seatbelt 410 compared to when the driver has directed a visual line or the face to the bicycle m3. Accordingly, the driver is more intensively restrained in the seat. As a result, the driver of the host vehicle M can be notified of the presence of an obstacle which is not recognized by the driver, and thus safety of the driver of the host vehicle M and an area around the host vehicle M can be further improved.

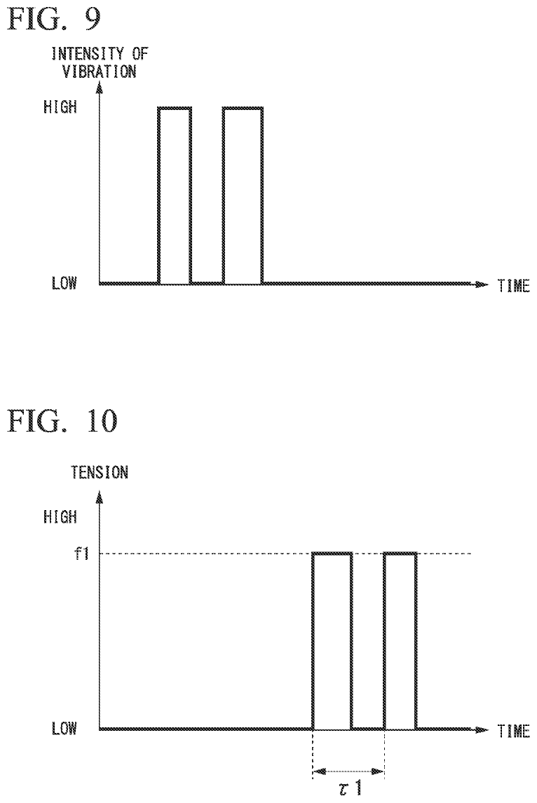

FIG. 9 is an explanatory view for a control timing of the vibrator 300, and FIG. 10 is an explanatory view for a control timing of the pretensioner 400. First of all, the vibration controller 130 controls the vibrator 300 to cause the steering wheel 310 to vibrate. For example, the vibration controller 130 may cause the steering wheel 310 to vibrate twice. After the steering wheel 310 has vibrated, the tension controller 140 controls the pretensioner 400 to intensify the tension of the seatbelt 410. Similar to those described above, the tension controller 140 may intensify the tension such that the seatbelt 410 is pulled twice. Particularly, in the tension controller 140, an interval for pulling the seatbelt 410 will be regarded as τ1, and a tension at this time will be regarded as f1.

The number of vibrations in the steering wheel 310 and the number of pulls of the seatbelt 410 are not limited to twice, and they may be once or may be three times or more.

In this manner, since the seatbelt 410 is pulled after the steering wheel 310 is caused to vibrate with a time difference therebetween, it is possible to more intensively call driver's attention to that an obstacle to be watched carefully is present on the lateral side and in an oblique direction behind the host vehicle M. A timing for vibrating the steering wheel 310 and a timing for pulling the seatbelt 410 may be the same, or the steering wheel 310 may be caused to vibrate after the seatbelt 410 is pulled. Returning to the flowchart of FIG. 6, in S104, when it is determined that the driver has directed a visual line or the face to all of the risk points PT (a case of eye-on), the determiner 150 determines whether or not manual driving of the driver of the host vehicle M is a preferable method of driving on the basis of the recognition results of the object recognition device 16 and the detection results of the vehicle sensor 18 (Step S112).

When it is determined that manual driving of the driver of the host vehicle M is a preferable method of driving, the output controller 120 causes the display device 200 to display the personified image 200a or the image object OB_{IMG} in a second mode (Step S114). At this time, the output controller 120 may cause the speaker 250 to output a sound. A personified image in the second mode is an example of “a predetermined image”.

Next, the tension controller 140 controls the pretensioner 400 to adjust the tension of the seatbelt 410 (Step S116).

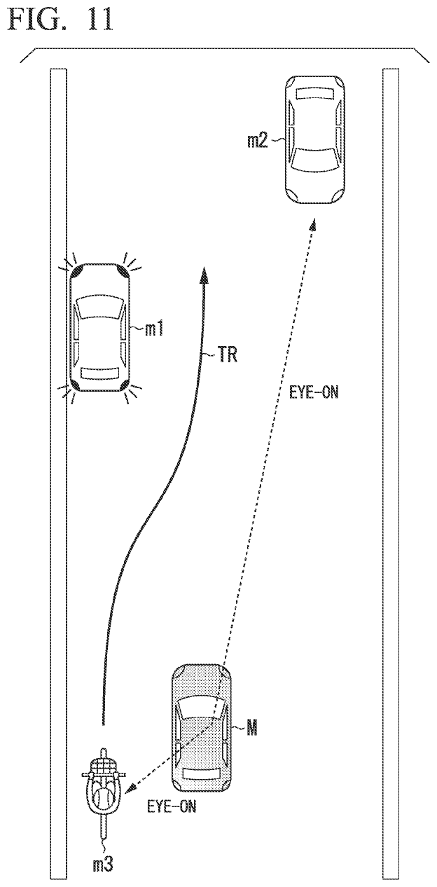

FIG. 11 is a view illustrating a scene in which a driver has directed a visual line or the face to all of the risk points PT. In the illustrated scene, the driver has directed a visual line or the face to each of the oncoming vehicle m2 and the bicycle m3 (the driver is in the eye-on state with respect to all of the risk points PT). In such a case, it is determined whether or not manual driving of the driver is the preferable method of driving.

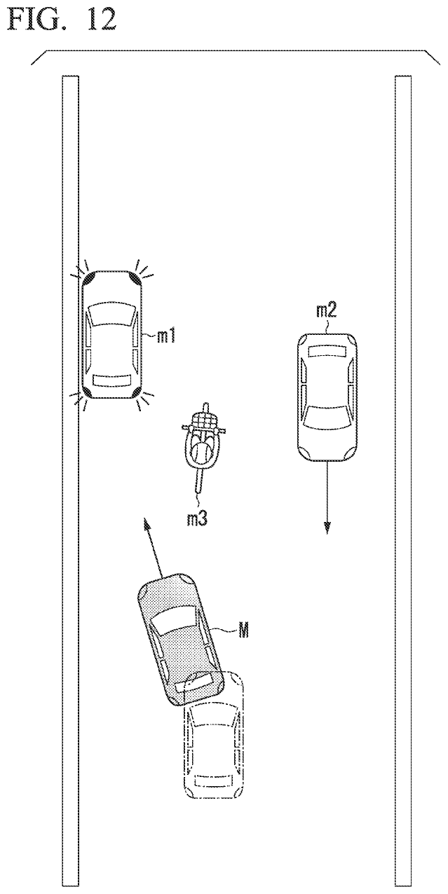

FIG. 12 is a view illustrating a scene of judging that manual driving of a driver is performed. For example, it is assumed that the host vehicle M is traveling on a road in a city area (a road where a mobile object other than an automobile such as a bicycle or a pedestrian may participate in traffic) and the host vehicle M has stopped, decelerated, or approached a road shoulder behind the preceding vehicle m1 so that the oncoming vehicle m2 will pass through the space on the lateral side of the preceding vehicle m1 earlier and the bicycle m3 will pass by the host vehicle M. In this case, since it is regarded that the host vehicle M has given way to the oncoming vehicle m2 and the bicycle m3, it is determined that driving of the driver of the host vehicle M is a preferable method of driving from a viewpoint of safe driving. The oncoming vehicle m2 and the bicycle m3 are examples of “a different mobile object”.

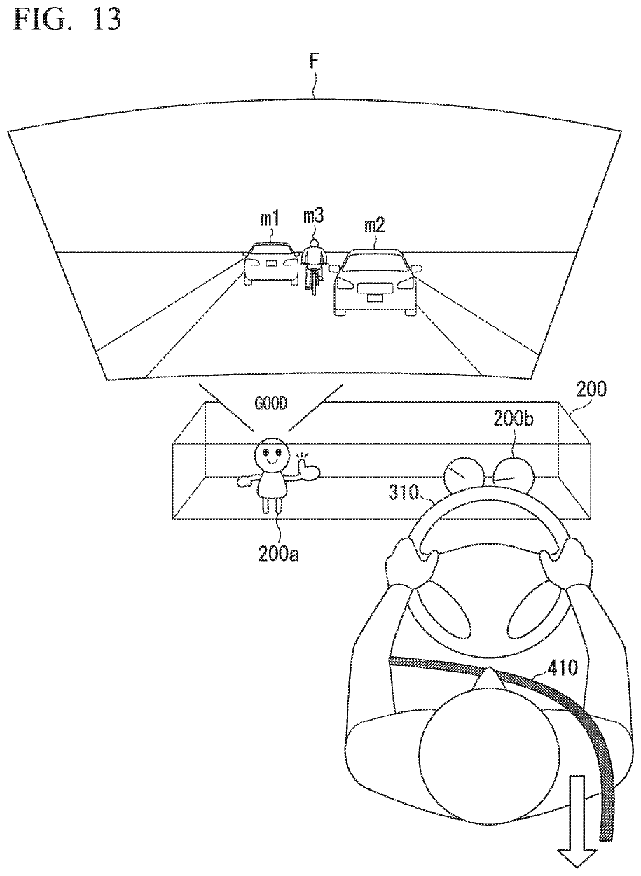

FIG. 13 is an explanatory view for the method of controlling each of the instruments when it is determined that driving is a preferable method of driving. For example, when it is determined that the driving is a preferable method of driving, in the second mode, the output controller 120 further causes a letter such as “good”, a pictograph, a figure, or the like to be displayed around the character while causing a portion of a character (for example, a hand, a foot, or the face) displayed as the personified image 200a to move by animation. In this manner, the driver who has performed preferable driving is complimented using the personified image 200a.

When it is determined that the driving is a preferable method of driving, the tension controller 140 controls the pretensioner 400 to adjust the tension of the seatbelt 410.

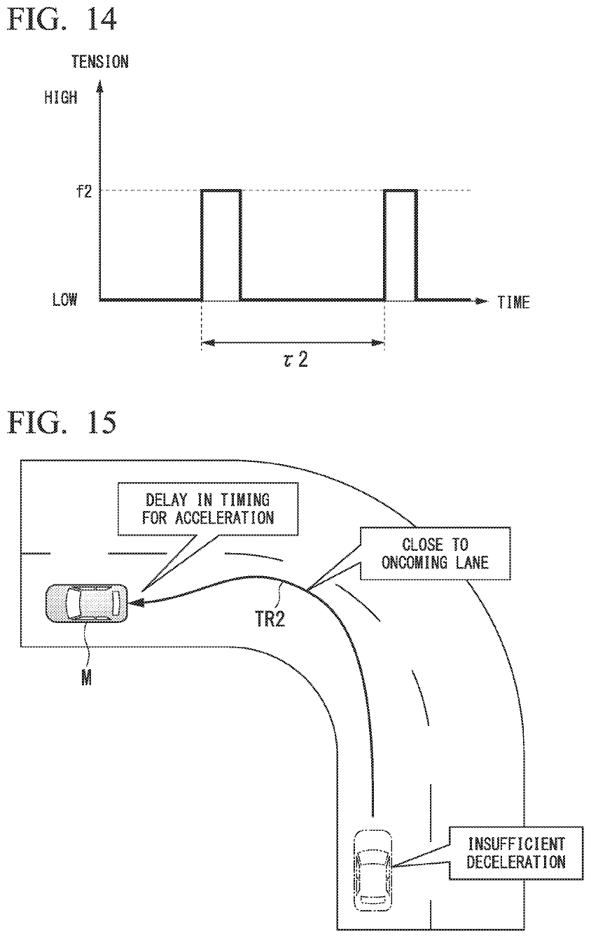

FIG. 14 is an explanatory view for a control timing of the pretensioner 400. As illustrated in the diagram, in the tension controller 140, when the seatbelt 410 is pulled for a plurality of times, an interval for pulling it will be regarded as τ2. Moreover, a tension thereof will be regarded as f2. The interval τ2 is an interval longer than the interval τ1, and the tension f2 is a tension smaller than the tension f1. Namely, when it is determined that the driving is a preferable method of driving, the tension controller 140 causes the seatbelt 410 to be pulled at a longer interval with a weaker force than when the driver has not directed a visual line or the face to the risk point PT. The driver can feel as if someone is tapping the shoulder in a manner of “tap” for a plurality of times by controlling the tension of the seatbelt 410 in this manner. As a result, the driver can feel that his/her own driving is complimented by a third person.

Returning to the flowchart of FIG. 6, in S112, when it is determined that manual driving of the driver of the host vehicle M is not preferable driving, the output controller 120 causes the display device 200 to display the personified image 200a or the image object OB_{IMG} in a third mode (Step S118). At this time, the output controller 120 may cause the speaker 250 to output a sound.

For example, in the third mode, the output controller 120 may cause the display device 200 to display only the character which has been paused as the personified image 200a. The processing of this flowchart hereby ends.

According to the first embodiment described above, the vehicle seatbelt device 1 includes the object recognition device 16 that recognizes circumstances around the host vehicle M, the vehicle sensor 18 that determines a state of the host vehicle M, the seatbelt 410 that restrains a portion of the body of the driver of the host vehicle M, the pretensioner 400 (an example of a tension adjustment mechanism) that is able to adjust the tension of the seatbelt 410, the determiner 150 that determines whether or not manual driving of the driver of the host vehicle M is a preferable method of driving on the basis of recognition results of the object recognition device 16 and detection results of the vehicle sensor 18, and the tension controller 140 that controls the pretensioner 400 such that a tension of the seatbelt 410 varies when the determiner 150 determines that driving is a preferable method of driving. Accordingly, awareness of safe driving of the driver can be improved.

### Second Embodiment

Hereinafter, a second embodiment will be described. In the first embodiment described above, it has been described that it is determined whether or not manual driving of the driver of the host vehicle M is a preferable method of driving under a condition that the driver has directed a visual line or the face to all of the risk points PT. In contrast, the second embodiment differs from the first embodiment described above in that it is determined whether or not manual driving of the driver of the host vehicle M is a preferable method of driving regardless of the direction of a visual line or the face of the driver to the risk point PT. Hereinafter, points different from the first embodiment will be mainly described, and description for points common to the first embodiment will be omitted. In the description of the second embodiment, description will be given with the same reference signs applied to the same parts of the first embodiment.

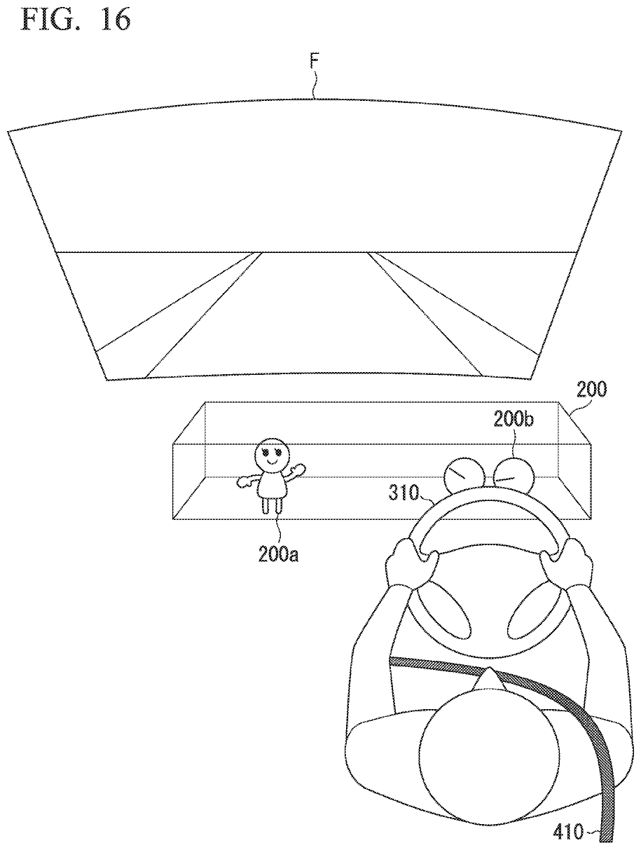

FIG. 15 is a view illustrating another scene of judging that manual driving of a driver is performed. In the scene of FIG. 15, the host vehicle M is traveling on a curved road. In the scene of FIG. 15, (i) the speed of the host vehicle M has exceeded a threshold (has not been able to be sufficiently decelerated) at the point of time when the host vehicle M has arrived at the curved road, (ii) the host vehicle M has come close to intruding into an oncoming lane during cornering so that it has repeatedly decelerated, and (iii) the host vehicle M has staggered at the end of the corner, thereby resulting in a delay in timing for acceleration, as a result. In such a case, the determiner 150 determines that manual driving of the driver of the host vehicle M is not preferable driving.

FIG. 16 is an explanatory view for the method of controlling each of the instruments when it is determined that driving is not preferable driving. For example, when it is not determined that the driving is a preferable method of driving, in the third mode, the output controller 120 causes the display device 200 to display only the character which has been paused as the personified image 200a. At this time, the tension controller 140 does not control the pretensioner 400 and does not intensify the tension of the seatbelt 410. Consequently, the driver does not feel that his/her own driving is complimented.

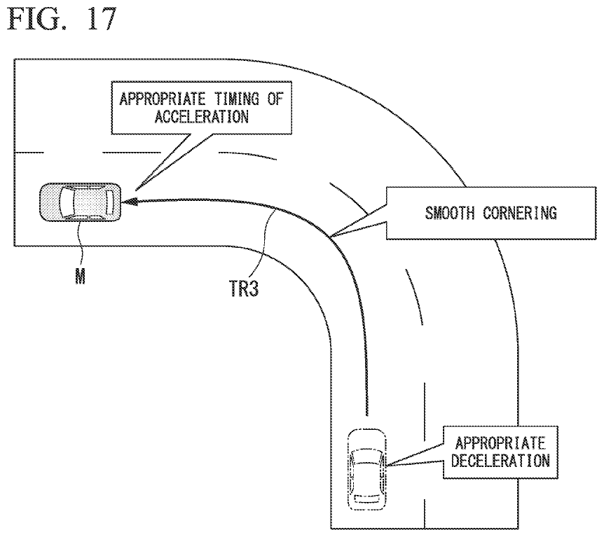

FIG. 17 is a view illustrating another scene of judging that manual driving of a driver is performed. In the scene of FIG. 17, similar to the scene of FIG. 15, the host vehicle M is traveling on a curved road. In the scene of FIG. 17, (i) the speed of the host vehicle M has become equal to or lower than a threshold (has been able to be sufficiently decelerated) at the point of time when the host vehicle M has arrived at the curved road, (ii) the host vehicle M has performed a smooth steering operation during cornering without approaching an oncoming lane, and (iii) the host vehicle M has been able to accelerate at an appropriate timing at the end of the corner, as a result. In such a case, the determiner 150 determines that manual driving of the driver of the host vehicle M is a preferable method of driving.

In this case, as illustrated in FIG. 13 as an example, in the second mode, the output controller 120 further causes a letter such as “good”, a pictograph, a figure, or the like to be displayed around the character while causing a portion of a character (for example, a hand, a foot, or the face) displayed as the personified image 200a to move by animation. Moreover, the tension controller 140 controls the pretensioner 400 to intensify the tension of the seatbelt 410. In this manner, the driver who has performed preferable driving is visually complimented using the personified image 200a or the driver who has performed preferable driving is complimented in a tactile manner by pulling the seatbelt 410.

According to the second embodiment described above, regardless of whether the driver has directed a visual line or the face to the risk point PT, the determiner 150 determines whether or not manual driving of the driver of the host vehicle M is a preferable method of driving. As a result, similar to the first embodiment, the driver who has performed preferable driving can be visually complimented using the personified image 200a or the driver who has performed preferable driving can be complimented in a tactile manner by pulling the seatbelt 410.

### Third Embodiment

Hereinafter, a third embodiment will be described. The third embodiment differs from the first or second embodiment described above in that in accordance with the number of times it has been determined that manual driving of the driver is the preferable method of driving, that is, the number of times manual driving has been complimented, (i) the mode of the personified image 200a is changed, (ii) a display frequency of the personified image 200a is changed, (iii) a frequency of changing the tension of the seatbelt 410 is changed, and (iv) an incentive is granted. Hereinafter, points different from the first and second embodiments will be mainly described, and description for points common to the first or second embodiment will be omitted. In the description of the third embodiment, description will be given with the same reference signs applied to the same parts of the first or second embodiment.

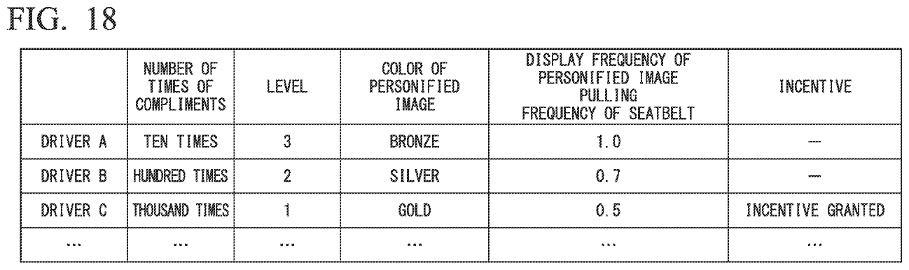

FIG. 18 is an explanatory view for details of control in accordance with the number of times manual driving has been complimented. For example, the output controller 120 may raise the level (the grade) indicating how good the driver is for the driver having a larger number of times of compliments, and the color of the character displayed as the personified image 200a may be progressively changed to more luxurious colors, such as bronze, silver, and gold, as the driver has achieved a higher level. Accordingly, the driver can have a desire to achieve the gold character. As a result, it can be expected that awareness of safe driving of the driver is continuously increased.

In addition, the output controller 120 may decrease the display frequency of the personified image 200a for a driver having a larger number of times of compliments (a driver at a higher level). It can be presumed that a driver having a larger number of times of compliments always keeps safe driving in mind with natural awareness, and it can be presumed that such a driver annoyingly feels display of the personified image 200a. Therefore, while annoyance of the driver is reduced, awareness of safe driving of the driver can be continuously maintained in a high state by decreasing the display frequency of the personified image 200a for the driver having a larger number of times of compliments.

From a similar viewpoint, the tension controller 140 may decrease the frequency of changing the tension of the seatbelt 410 for the driver having a larger number of times of compliments (a driver at a higher level).

In addition, the determiner 150 may determine granting of an incentive to a driver having the number of times of compliments in a certain level. For example, an incentive indicates that an insurance fee of the host vehicle M is reduced, or a discount coupon or points which can be used in a shopping site or the like are granted. Awareness of safe driving of the driver can be further enhanced by granting such an incentive.

According to the third embodiment described above, in accordance with the number of times it has been determined that manual driving of the driver is the preferable method of driving, that is, the number of times manual driving has been complimented, (i) the mode of the personified image 200a is changed, (ii) a display frequency of the personified image 200a is changed, (iii) a frequency of changing the tension of the seatbelt 410 is changed, and (iv) an incentive is granted. Accordingly, awareness of safe driving of the driver can be further enhanced.

Hereinabove, forms for performing the present invention have been described using the embodiments, but the present invention is not limited to the embodiments in any way. Various modifications and replacements can be added within a range not departing from the gist of the present invention.

What is claimed is:

1. A vehicle seatbelt device comprising:
a recognizer that recognizes circumstances around a vehicle;
a determiner that determines a state of the vehicle;
a seatbelt that restrains a portion of the body of a driver of the vehicle;
a tension adjustment mechanism that is able to adjust the tension of the seatbelt;
a determiner that determines whether or not driving of the driver is a preferable method of driving on the basis of the circumstances recognized by the recognizer and the state determined by the determiner; and
a controller that controls the tension adjustment mechanism such that a tension of the seatbelt varies when the determiner determines that driving of the driver is the preferable method of driving.

2. The vehicle seatbelt device according to claim 1,
wherein the determiner determines that driving of the driver is the preferable method of driving when the vehicle is traveling in a city area and the vehicle decelerates or stops in order to give way to a different mobile object.

3. The vehicle seatbelt device according to claim 1,
wherein the determiner determines that driving of the driver is the preferable method of driving when a speed of the vehicle is equal to or lower than a threshold at a point of time when the vehicle arrives at a curved road.

4. The vehicle seatbelt device according to claim 1 further comprising:
a display that displays an image,
wherein the controller causes the display to display a predetermined image when the determiner determines that driving of the driver is the preferable method of driving.

5. The vehicle seatbelt device according to claim 4,
wherein the controller changes a mode of the predetermined image between when the determiner determines that driving of the driver is the preferable method of driving and when the determiner determines that driving of the driver is not the preferable method of driving.

6. The vehicle seatbelt device according to claim 4,
wherein the controller changes a mode of the predetermined image in accordance with the number of times the determiner has determined that driving of the driver is the preferable method of driving.

7. The vehicle seatbelt device according to claim 4,
wherein the controller changes a display frequency of the predetermined image in accordance with the number of times the determiner has determined that driving of the driver is the preferable method of driving.

8. The vehicle seatbelt device according to claim 7,
wherein the controller decreases the display frequency of the predetermined image when the number of times the determiner has determined that driving of the driver is the preferable method of driving increases.

9. The vehicle seatbelt device according to claim 1,
wherein the controller changes a frequency of changing a tension of the seatbelt in accordance with the number of times the determiner has determined that driving of the driver is the preferable method of driving.

10. The vehicle seatbelt device according to claim 9,
wherein the controller decreases a frequency of changing a tension of the seatbelt when the number of times the determiner has determined that driving of the driver is the preferable method of driving increases.
